(19) United States
(12) Patent Application Publication
(10) Pub. No.: US 2017/0356164 A1
(43) Pub. Date: Dec. 14, 2017

(54) Wear Prediction and Notification System

(71) Applicant: Caterpillar Inc., Peoria, IL (US)

(72) Inventors: Roger L. Recker, Dunlap, IL (US); Eric J. Johannsen, Washington, IL (US); David M. Longanbach, Peoria, IL (US); Asif Khan, Peoria, IL (US)

(73) Assignee: Caterpillar Inc., Peoria, IL (US)

(21) Appl. No.: 15/178,223

(22) Filed: Jun. 9, 2016

(51) Int. Cl. E02F 9/26; G06K 7/10; B62D 55/14; B62D 55/21; E02F 3/76

(52) U.S. Cl. CPC E02F 9/267; G06K 7/10366; E02F 3/7604; B62D 55/21; B62D 55/14; E02F 3/7609

(57) ABSTRACT

An ID tag is disposed on a plurality of components of a machine. A controller stores a usage threshold for each component, receives signals from an ID tag reader, and associates an identification number from each ID tag with a component of the machine. The controller determines previous usage data for each component, determines an extent of usage of the machine since generation of the previous usage data, determines current usage data for each component based upon the extent of usage of the machine and the previous usage data, and compares the current usage data for each component to the usage threshold for each component. The controller generates an alert for each component in which the current usage data for that component exceeds its usage threshold and transmits the alert to a system remote from the machine.

### TECHNICAL FIELD

This disclosure relates generally to a wear prediction system and, more particularly, to a system and method for evaluating machine usage and predicting wear of components on the machine and generating alerts or notifications based upon the predicted wear.

### BACKGROUND

Machines are used to perform various operations in different industries, such as construction, mining, transportation, and the like. Such machines may include an upper frame supported on an undercarriage. The undercarriage includes ground engaging members which provide propulsion to the machine. Operation of the machines results in wear to various components of the undercarriage including the ground engaging members. For example, the undercarriage may include tracks, drive sprockets, idlers, and track rollers. The tracks may be formed of a plurality of track links. Each component of the undercarriage may undergo wear due to contact with other components of the track assembly and/or a ground surface.

Predicting wear of such components may be challenging based upon different operating conditions under which the machines may operate. In addition, components may be moved from one machine to another to increase the productivity of a fleet or plurality of machines. In some instances, systems and components have been used to actively sense wear of components of the undercarriage of the machines.

U. S. Patent Publication No. 2015/0081166 discloses a system in which sensing devices are mounted on components of an undercarriage to sense wear of the components. The sensing devices include probes that wear away as portions of the undercarriage components wear away. Signals may be sent from the sensing devices to a monitoring device remote from the sensing device.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, a wear prediction and notification system for a plurality of components mounted on a machine includes a usage sensor for generating usage signals indicative of an extent of usage of the machine, a plurality of ID tags with each ID tag being disposed on one of the plurality of components and having a unique identification number, and an ID tag reader disposed on the machine to generate signals indicative of the unique identification number of each ID tag. A controller is configured to store a usage threshold for each component, receive the signals from the ID tag reader, and associate each unique identification number with a component of the machine. The controller is further configured to determine previous usage data for each component, determine an extent of usage of the machine since generation of the previous usage data based upon the usage signals from the usage sensor, determine current usage data for each component based upon the extent of usage of the machine and the previous usage data, and compare the current usage data for each component to the usage threshold for each component. The controller generates an alert for each component in which the current usage data for that component exceeds its usage threshold and transmits the alert to a system remote from the machine.

In another aspect, a method of wear prediction and notification for a plurality of components mounted on a machine includes storing a usage threshold for each component, receiving signals from an ID tag reader on-board the machine indicative of a unique identification number of each of a plurality of ID tags with each ID tag being disposed on one of the plurality of components, and associating each unique identification number with a component of the machine. The method further includes determining previous usage data for each component, determining an extent of usage of the machine since generation of the previous usage data based upon usage signals from a usage sensor indicative of an extent of usage of the machine, determining current usage data for each component based upon the extent of usage of the machine and the previous usage data, and comparing the current usage data for each component to the usage threshold for each component. An alert is generated for each component in which the current usage data for that component exceeds its usage threshold and the alert is transmitted to a system remote from the machine.

In still another aspect, a machine includes a prime mover, a plurality of components operatively connected to the prime mover to propel the machine, a usage sensor for generating usage signals indicative of an extent of usage of the machine, a plurality of ID tags with each ID tag being disposed on one of the plurality of components and having a unique identification number, and an ID tag reader disposed on the machine to generate signals indicative of the unique identification number of each ID tag. A controller is configured to store a usage threshold for each component, receive the signals from the ID tag reader, and associate each unique identification number with a component of the machine. The controller is further configured to determine previous usage data for each component, determine an extent of usage of the machine since generation of the previous usage data based upon the usage signals from the usage sensor, determine current usage data for each component based upon the extent of usage of the machine and the previous usage data, and compare the current usage data for each component to the usage threshold for each component. The controller generates an alert for each component in which the current usage data for that component exceeds its usage threshold and transmits the alert to a system remote from the machine.

### BRIEF DESCRIPTION OF THE DRAWINGS

FIG. 1 depicts a schematic illustration of an exemplary machine with which the principles disclosed herein may be used;

FIG. 2 depicts a schematic illustration of a pair of track links and a track pin assembly including an insert with an ID tag exploded therefrom;

FIG. 3 depicts a schematic illustration of track roller including an insert with an ID tag exploded therefrom;

FIG. 4 depicts a schematic illustration of an idler including an insert with an ID tag exploded therefrom;

FIG. 5 depicts a diagrammatic illustration a wireless communications system;

FIG. 6 depicts a diagrammatic illustration of a wear prediction and notification system; and

FIG. 7 depicts a flowchart illustrating operation of a machine including the wear prediction and notification system.

### DETAILED DESCRIPTION

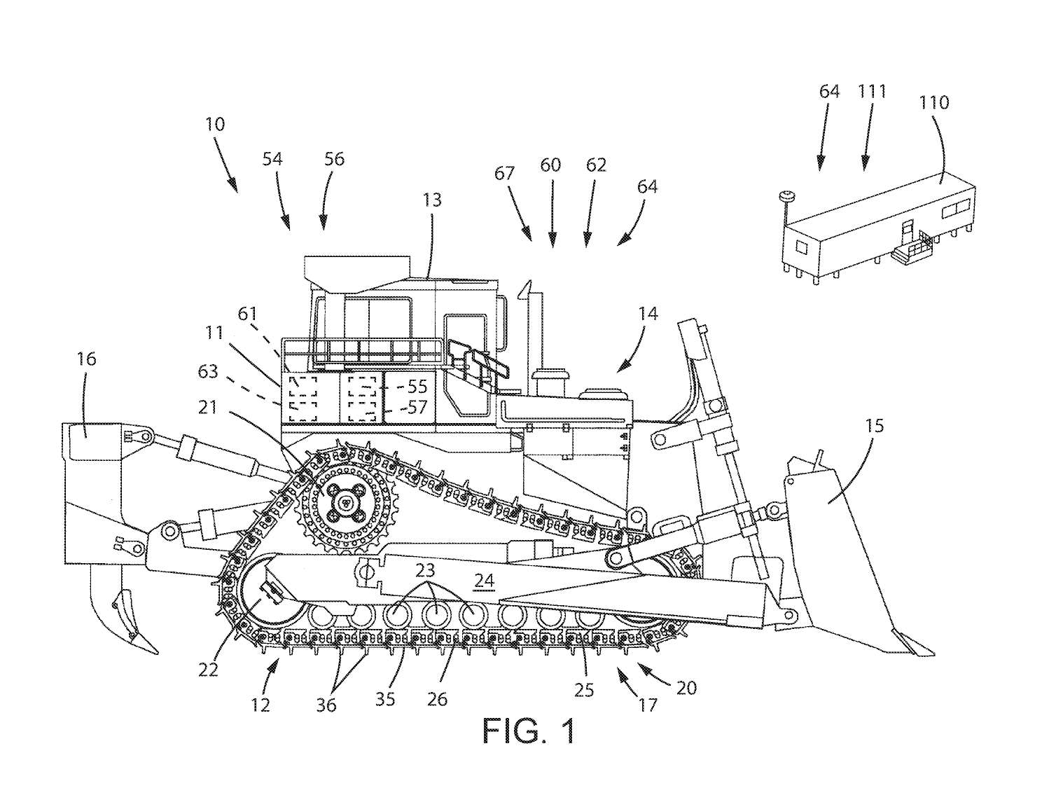

FIG. 1 depicts an exemplary machine 10 such as a track-type tractor. However, the present disclosure may be embodied in any type of machine having an undercarriage assembly, for example, skid steers, dozers, excavators, backhoes, track loaders, and the like. The machine 10 includes an upper body 11 supported by an undercarriage generally depicted at 12. The upper body 11 may include an operator station 13. A prime mover, such as an engine depicted generally at 14, may be disposed on the upper body 11. The prime mover is configured to generate power to propel the machine 10, and may also operate one or more work implements such as blade 15 and ripper 16.

The undercarriage 12 may include a pair of assemblies 17 on opposing sides of the machine 10. The assembly 17 may include a track 20, a drive sprocket 21, at least one idler 22, a plurality of track rollers 23, and a frame assembly 24. The track 20 may form a continuous structure operatively coupled to the drive sprocket 21, the idlers 22, and the track rollers 23. Each of drive sprockets 21, idlers 22, and track rollers 23 are rotatable while the track 20 moves about those components. Operation of the engine 14 and a transmission (not shown), which are operatively connected to the drive sprockets 21, may be controlled by a control system 60 and a controller 61.

The frame assembly 24 may carry the idlers 22. The frame assembly 24 may include multiple members (not shown) movable longitudinally relative to one another. During operation, relative movement between the members of the frame assembly 24 may move the idlers 22 relative to one another. Further, rotation of the drive sprocket 21 drives the track 20 along the idlers 22 and the track rollers 23 while the track engages a ground surface to propel the machine 10. The drive sprocket 21 may be driven in different directions to propel the machine 10 in forward or reverse directions. Further, the machine 10 may be steered by providing differential power to the drive sprockets 21 of the corresponding assemblies 17.

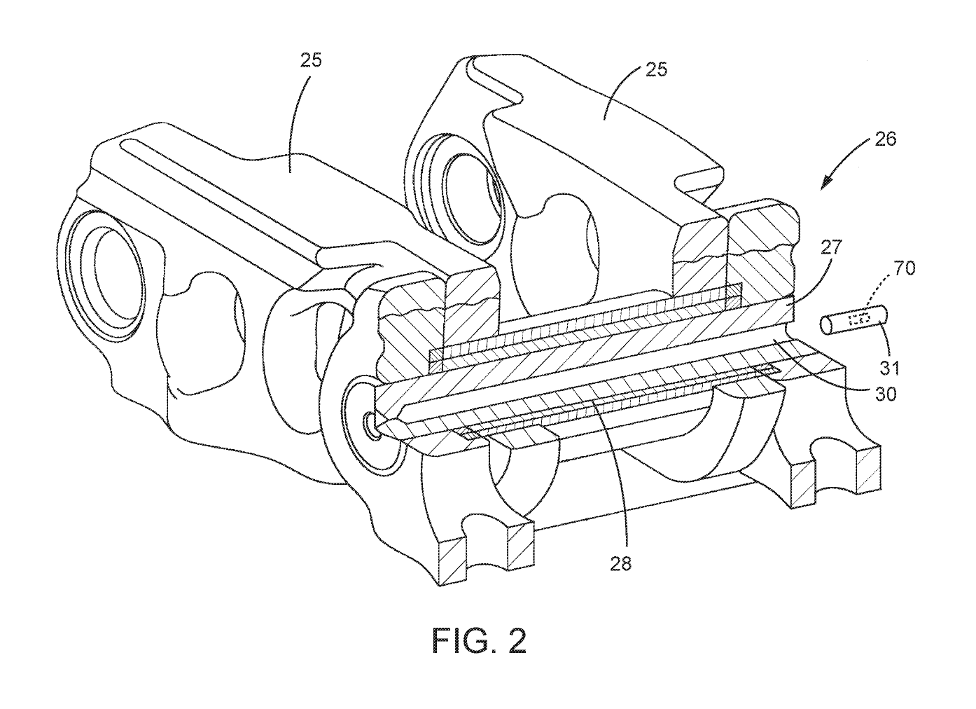

The track 20 may include a plurality of track components including interconnected track links 25 (FIG. 2). Adjacent track links 25 may be rotatably coupled together via a track pin assembly 26. The track pin assembly 26 may be engaged by teeth of the drive sprocket 21 to drive the track 20 around the drive sprocket 21, the idlers 22, and the track rollers 23. The track pin assembly 26 may include a pin 27 and the bushing 28. Various surfaces of the pin 27 and/or the bushing 28 may undergo wear during operation. One or both ends of the pin 27 may include a bore 30 that operates as a port through which oil or grease may be supplied to lubricate the track pin assembly 26. The bore 30 may be removably sealed by a stopper or insert 31. In one embodiment, the insert 31 may be formed of a resilient material such as rubber.

The track 20 may further include a plurality of track shoes 35 secured to the track links 25. Each track shoe 35 may include a connecting portion configured to be secured to one or more of the track links 25 and a ground engaging portion 36 configured to contact the ground. The ground engaging portion 36 may include one or more portions (e.g., grouser bars) that provide increased traction between the track shoes 35 and the ground.

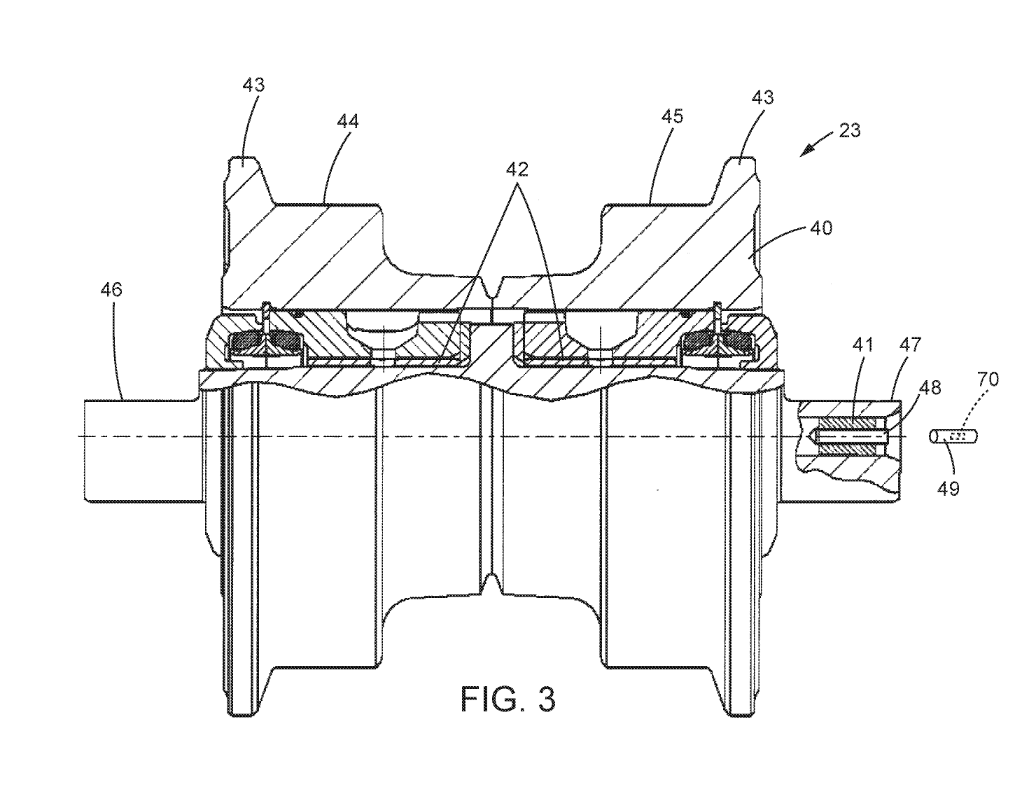

Referring to FIG. 3, track roller 23 includes a roller body 40, a roller shaft 41, and a bushing 42. The roller body 40 facilitates movement of the track 20 around the undercarriage 12. The roller body 40 includes a pair of spaced apart flanges 43 and track 20 contacts with the roller body 40 along surfaces 44, 45 adjacent the flanges 43, respectively. The roller body 40 includes a first end 46 and a second end 47 opposite to end 46. One or both ends of the roller shaft 41 may include a bore 48 that operates as a port through which oil or grease may be supplied to lubricate the track roller 23. The bore 48 may be removably sealed by a stopper or insert 49. In one embodiment, the insert 31 may be formed of a resilient material such as rubber. Movement of the track 20 relative to the flange 43 as the machine 10 operates may cause rubbing and frictional forces that may tend to wear the track roller 23.

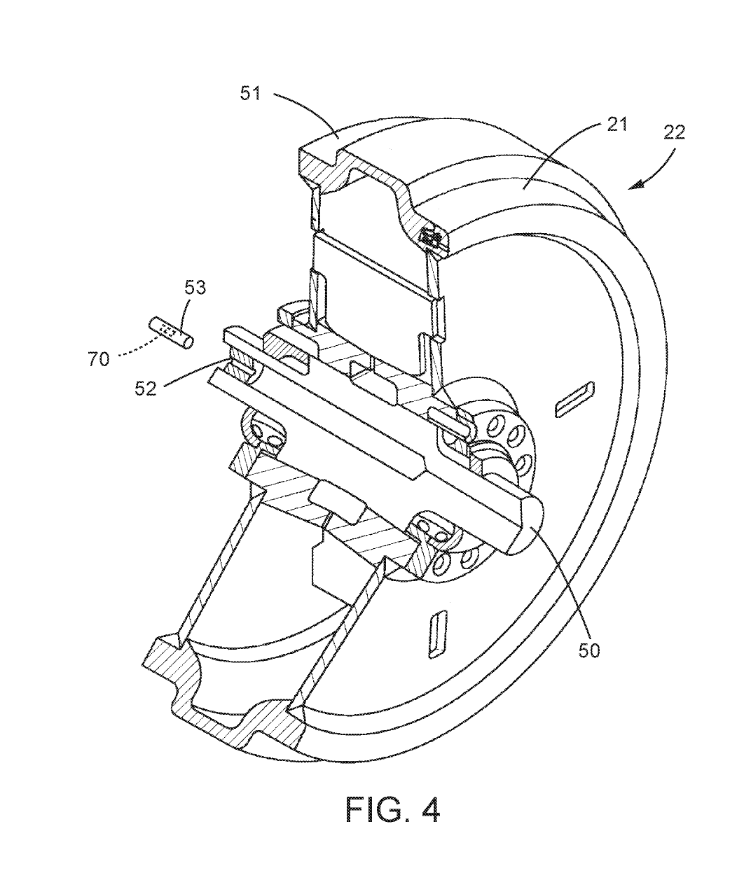

FIG. 4 depicts idler 22. Idler 22 rotates about idler shaft 50 and includes a pair of spaced apart outer surfaces 51 along which the track links 25 may pass. Idler shaft 50 and outer surfaces 51 may undergo wear during operation of the machine 10. One or both ends of the idler shaft 50 may include a bore 52 that operates as a port through which oil or grease may be supplied to lubricate the idler 22. The bore 52 may be removably sealed by a stopper or insert 53. In one embodiment, the insert 53 may be formed of a resilient material such as rubber.

Machine 10 may be controlled by a control system 60 as shown generally by an arrow in FIG. 1 indicating association with the machine 10. The control system 60 may include an electronic control module or controller 61 and a plurality of sensors. The controller 61 may receive input signals from an operator. The controller 61 may control the operation of various aspects of the machine 10 including the drivetrain and the hydraulic systems.

The controller 61 may be an electronic controller that operates in a logical fashion to perform operations, execute control algorithms, store and retrieve data and other desired operations. The controller 61 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller 61 such as power supply circuitry, signal conditioning circuitry, driver circuitry, and other types of circuitry.

The controller 61 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 61 may be implemented in hardware and/or software without regard to the functionality. The controller 61 may rely on one or more data maps relating to the operating conditions and the operating environment of the machine 10 and the work site 100 that may be stored in the memory of controller. Each of these data maps may include a collection of data in the form of tables, graphs, and/or equations.

The control system 60 and controller 61 may be located on the machine 10 as an on-board control system 62, as shown generally by an arrow in FIG. 1 indicating association with the machine, with an on-board controller 63, or may be distributed with components such as an off-board controller 111 also located remotely from or off-board the machine such as at a command center 110 (FIG. 1) located on-site or off-site. The functionality of control system 60 may be distributed so that certain functions are performed at machine 10 and other functions are performed remotely.

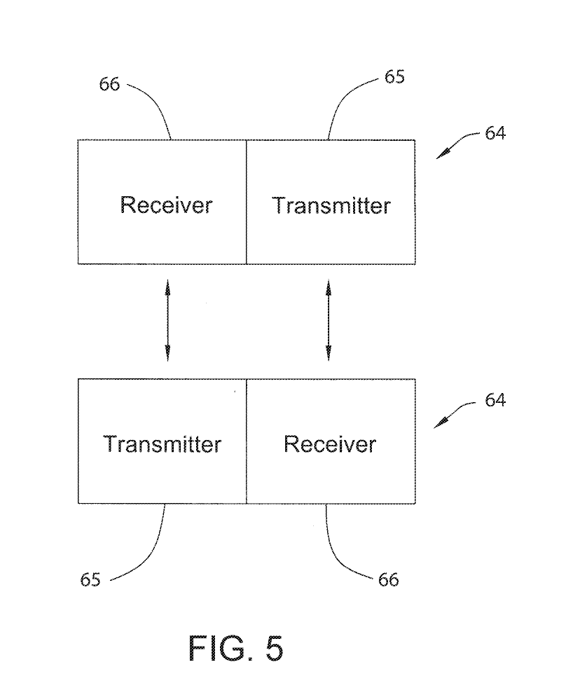

Each of machine 10 and the command center 110 may include a wireless communications system 64 to permit wireless transmission of information between the machine 10 and the command center 110. In one embodiment depicted in FIG. 5, each wireless communications system 64 may include a transmitter 65 for transmitting signals from one wireless communications system and a receiver 66 for receiving signals from a transmitter system of another wireless communications system. In some instances, the transmitter 65 and the receiver 66 may be combined as a transceiver system. The wireless communications system 64 may implement or utilize any desired system or protocol including any of a plurality of communications standards.

Referring back to FIG. 1, machine 10 may be equipped with a plurality of machine sensors that provide data indicative (directly or indirectly) of various operating parameters of the machine and/or the operating environment in which the machine is operating. The term “sensor” is meant to be used in its broadest sense to include one or more sensors and related components that may be associated with the machine 10 and that may cooperate to sense various functions, operations, and operating characteristics of the machine and/or aspects of the environment in which the machine is operating.

A position sensing system 54, as shown generally by an arrow in FIG. 1 indicating association with the machine 10, may include a position sensor 55, to sense the position and orientation (i.e., the heading, pitch, roll or tilt, and yaw) of the machine relative to the work site 100. The position sensor 55 may include a plurality of individual sensors that cooperate to generate and provide position signals to controller 61 indicative of the position and orientation of the machine 10.

In one example, the position sensor 55 may include one or more sensors that interact with a positioning system such as a global navigation satellite system or a global positioning system to operate as a position sensor. In another example, the position sensor 55 may further include an inertial measurement unit and/or a slope or inclination sensor such as pitch angle sensor for measuring the slope or inclination of the machine 10 relative to a ground or earth reference. The controller 61 may use position signals from the position sensor 55 to determine the position of the machine 10 within work site 100. In other examples, the position sensor 55 may include an odometer or another rotation sensing sensor, a perception based system, or may use other systems such as lasers, sonar, or radar to determine all or some aspects of the position of machine 10.

If desired, the position sensing system 54 may also be used to determine the ground speed of and/or distance traveled by machine 10. Other sensors or a dedicated ground speed sensor may alternatively be used to determine the ground speed of the machine 10.

Other sensors or dedicated travel distance sensors 57 (including an odometer) may alternatively be used to determine the distance the machine 10 travels during operation. Regardless of the type of sensor used to provide data, a travel distance sensing system, indicated generally at 56, which determines the distance the machine 10 travels, may use data from the sensor to determine the travel distance. In a further embodiment, a sensor (not shown) may be operative to determine rotation or movement of components of the undercarriage 12 and the travel distance sensing system 56 may use that data to determine or approximate the travel distance of the machine 10.

During operation, one or more undercarriage components, such as, for example, the track rollers 23, the track shoes 35, the track links 25, and the track pin assemblies 26, may undergo wear. These undercarriage components may require replacement and/or repair based on an extent of wear. Control system 60 includes a wear prediction and notification system 67 that monitors the operation of the machine 10 and, based upon the usage of the machine, predicts maintenance and replacement intervals or cycles for the components of undercarriage 12 and may further provide notification of such intervals to desired personnel or systems. In some instances, the wear prediction and notification system 67 may also utilize or account for the operating conditions encountered by the machine 10 to predict maintenance and replacement intervals or cycles.

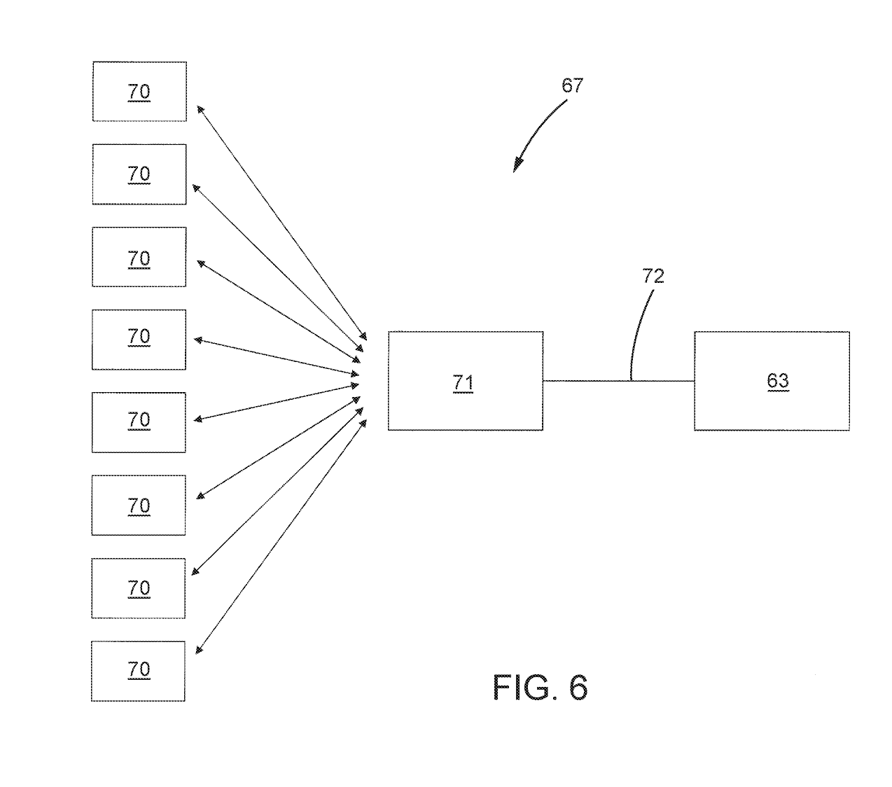

Referring to FIG. 6, wear prediction and notification system 67 includes a plurality of wireless auto identification or ID tags 70 and an ID tag reader 71. The ID tags 70 may take any form and store or hold any type of information therein. For example, each ID tag 70 may store a unique identifying or serial number that is associated with each component or type of component of the undercarriage 12. In another example, additional information may be stored on the ID tag 70. Information stored on the ID tags 70 may be read wirelessly by the ID tag reader 71. In one example, the ID tags 70 may be a passive RFID tags but the present disclosure is not limited to any type of ID tag or any frequency of operation (e.g., radio frequencies). In particular, the frequency and type of ID tags 70 may be dependent upon a plurality of factors including the type and amount of information to be stored as well as the operating conditions and distance between the ID tags and the ID tag reader 71. In some instances, it may be desirable to use active ID tags.

An ID tag 70 may be secured to each component of the undercarriage 12 such as each drive sprocket 21, each idler 22, each track roller 23, and each track link 25. In some instances, an ID tag 70 may be secured to one component and associated with a plurality of components. This may be desirable for components that are expected to or may be replaced at the same time. In one example, a single ID tag 70 may be secured to one track link 25 but associated with all of the track links of a track 20.

Each ID tag 70 may be disposed on or secured to its respective component of the undercarriage 12 in any desired manner. In the examples depicted in FIGS. 2-4, an ID tag 70 may be inserted into or embedded in the inserts 31 for the bore 30 of one or more of the track pin assemblies 26, inserted into or embedded in the inserts 49 for the bore 48 of each track roller 23, and inserted into or embedded in the inserts 53 for the bore 52 of each idler 22.

The ID tag reader 71 may be disposed on or mounted at any desired location on machine 10 at which it is able to read the ID tags 70 of the undercarriage 12. When operating with passive ID tags 70, the ID tag reader 71 may generate wireless (e.g., radio frequency) signals that reach the ID tags. Energy from the wireless signals that reach the ID tags 70 is operative to permit information stored on the ID tags 70 to be transmitted or reflected back to the ID tag reader 71.

ID tag reader 71 may be operatively connected to on-board controller 63 such as through wired connection 72. Information regarding each component associated with an ID tag 70 may be stored within the on-board controller 63. For example, in addition to the serial number of the ID tag 70, the on-board controller 63 may store the position of each component on machine 10 as well as a description of the component, if desired. In other words, the on-board controller 63 may store a unique serial number associated with an ID tag 70 as well as the component's unique location on the machine and a description of the component.

In one embodiment, operational or usage data associated with each component may be associated with its serial number stored within on-board controller 63. Such usage data may reflect the status, state, or usage of the component. For example, the on-board controller 63 may also store the number of hours the component has been used and/or the distance the machine 10 has traveled since the component was installed or first placed in service.

A plurality of usage thresholds may be stored within controller 61, such as within on-board controller 63 and/or off-board controller 111. The usage thresholds may identify times when maintenance or replacement of the components is desirable. In one embodiment, the usage thresholds may be specified in terms of the distance the machine 10 has traveled. In another embodiment, the usage thresholds may be specified in terms of the hours of operation of the machine 10. In some instances, the distance the machine 10 has traveled may be more reflective of the actual wear on the components than the hours of operation.

In one embodiment, the usage thresholds may be set based upon the type of operating conditions in which the machine 10 is operating. For example, different usage thresholds may be set for a particular component depending upon the type of conditions in which the machine will be operating. For example, the conditions of the soil or material upon which the undercarriage 12 is traveling may have a significant impact on the wear experienced by the components of the undercarriage. For example, operating the machine 10 in conditions in which the soil is relatively sandy and has a relatively high moisture content will result in relatively fast wear of the drive sprockets 21, idlers 22, track rollers 23, and track links 25. However, the track shoes 35 may experience relatively slow wear. In another example, operating the machine 10 in relatively sandy, relatively low moisture content conditions will result in relatively high wear on the drive sprockets 21, idlers 22, track rollers 23, and track links 25 but less than that incurred when operating on relatively sandy and high moisture content soil. The track shoes 35 may experience wear that is higher as the moisture content of the sandy conditions decreases.

In still another example, operating the machine 10 on black dirt will result in slower wear of the drive sprockets 21, idlers 22, track rollers 23, and track links 25 but higher wear of the track shoes 35. Still further, operating the machine 10 on rocks or rocky material will result in still slower wear of the drive sprockets 21, idlers 22, track rollers 23, and track links 25 but higher wear of the track shoes 35 due to increased slippage caused by reduced traction on the rocks.

In another embodiment, the direction and speed at which the machine 10 is operating may also impact the usage thresholds. For example, certain components of the undercarriage may wear faster when the machine 10 is operating in reverse as compared to operating in a forward direction. In addition, in some situations, the faster the machine 10 is operating the more result is more wear even for the same distance traveled. For example, 1000 miles of travel at a relatively slow speed may be equivalent in terms of wear to 900 miles at a higher speed.

The controller 61 may thus store a plurality of usage thresholds for each type of component of the undercarriage 12 (e.g., drive sprockets 21, idlers 22, track rollers 23, track links 25) with each usage threshold corresponding to a set of operating conditions at which the machine may be operating. During operation, an operator, management personnel, or another system may determine or estimate the operating conditions at the work site in order to select one of the usage thresholds.

In another embodiment, the controller 61 may include data maps specifying the usage thresholds based upon the geographical location of the machine 10 and the on-board controller may determine the usage threshold based upon the location of the machine as determined by the position sensing system 54. In some instances, the moisture content at the work site may be determined or estimated by an operator, management personnel, or in an automated manner based upon another system.

In another embodiment, the usage thresholds may be established for a specified or generalized type of operating conditions and the usage of the machine 10. In some operations, such a generalized usage threshold may be used regardless of the type of operating conditions in which the machine is being used. In other operations, the tracked usage of the machine 10 may be modified based upon changes in the operating conditions from the specified or generalized type to create a calculated usage. For example, with a generalized usage threshold for a component, a multiplier or condition factor may be used to adjust the calculation of usage based upon the actual usage and the condition factor. As example, if the threshold were set at 1000 miles for a component and the machine 10 is operating in conditions that will increase wear by 25%, the wear prediction and notification system 67 may increase the actual distance traveled by the machine 10 by 25% to arrive at a tracked usage of 125% of the actual distance.

The controller 61 may track the usage data of each component associated with each ID tag 70. To do so, the controller 61 may track the usage of each component and update the usage data each time the machine is operated. In an example, each component may be rated for a predetermined usage (e.g., a distance traveled by the machine or a number of hours of machine operation). As stated above, the wear prediction and notification system 67 may be configured to adjust the usage data to reflect the operating conditions of the machine 10 or otherwise reflect the operating conditions in the usage data. In one example, the wear prediction and notification system 67 may be configured to operate based upon a specified type of soil and utilize usage thresholds based upon the specified type of soil. To the extent that the type of soil that the machine is operating on is different from that for which the wear prediction and notification system 67 is configured, the wear prediction and notification system may increase or decrease the usage that is reflected within the controller 61. For example, if the wear prediction and notification system 67 is configured for black dirt and the machine 10 is operating in moist sand, each mile of operation may be increased by a predetermined percentage for the drive sprockets 21, idlers 22, track rollers 23, and track links 25 and decreased for the track shoes 35. A similar but opposite process may be used when operating in conditions in which the wear on the drive sprockets 21, idlers 22, track rollers 23, and track links 25 is decreased and the wear on the track shoes 35 is increased.

The controller 61 may be configured to determine and report the useful remaining life of the various components of the undercarriage 12. In doing so, the controller 61 may compare the usage data for each component to the usage thresholds stored within the on-board controller. The controller 61 may report to a remote system any of the status or usage data of the components, the expected time intervals for upcoming maintenance or replacement, and any alerts upon the usage data exceeding a usage threshold. The data may be transmitted in any manner including wirelessly via the wireless communications system 64 to a location remote from machine 10 such as to a back office system, or to any other desired location or personnel.

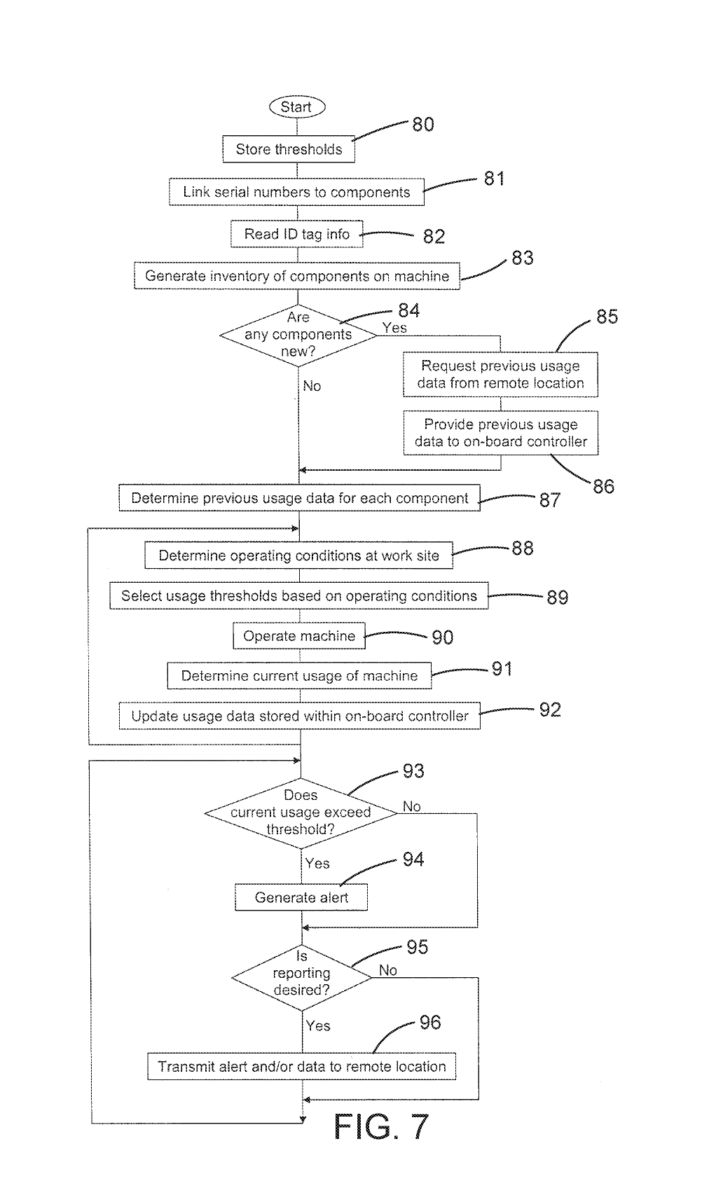

FIG. 7 depicts one example of the operation of the wear prediction and notification system 67. In this example, the usage thresholds and the calculation of usage data may be carried out on-board machine 10 by on-board controller 63. At stage 80, usage thresholds related to each component of the undercarriage 12 may be set or stored within on-board controller 63. The usage thresholds may correspond or be used to identify service, inspection and/or replacement intervals for the various components of the undercarriage 12. The usage thresholds may be based upon distance traveled by the machine 10 or the hours in which the machine has been in operation. A plurality of usage thresholds for each component may be stored within the on-board controller 63 with each threshold corresponding to a different set of operating conditions at which the machine 10 may be operating.

Each component of the undercarriage 12 may include one of the ID tags 70 mounted or associated thereon. Each ID tag 70 includes a serial number or other unique identifying number and the unique serial number for each component may be stored at stage 81 within on-board controller 63. In doing so, the on-board controller is essentially creating an inventory of each of the components of the undercarriage 12 of machine 10. The on-board controller 63 may also store the location of each component and/or a description of the component (e.g., left drive sprocket) as well as its current usage (e.g., distance traveled) as part of a data set associated with each component. In other words, the data set for each component may include, at a minimum, a serial number or another identifying number together with usage data or history for such component. For new or reconditioned components, the distance traveled will initially be set at zero.

At stage 82, the ID tag reader 71 may scan or read all of the ID tags 70 on the machine 10. The on-board controller 63 may utilize the information from the scanned ID tags 70 to take or create an inventory or list at stage 83 of all of the ID tags on the machine. At decision stage the 84, on-board controller 63 may compare each of the serial numbers read by the ID tag reader 71 to the existing inventory of the components of the undercarriage 12 of the machine 10 stored within the on-board controller 63 to determine whether any of the components identified by the ID tag reader were not stored or listed in the previous inventory of the undercarriage components on the machine.

Usage history for each component may be stored in a database remote from machine 10 so that the usage history of each component may be tracked even when the component is moved from one machine to another, or even from one location to another. Such a remote system may be operated or maintained by the owner of a plurality of machines, by an organization providing maintenance for a plurality of machines, or any other entity. If any of the components identified by the ID tag reader 71 are not stored or listed in the on-board component inventory, the on-board controller 63 may, at stage 85, request from a remote system the usage history or data for each component that was not stored in the on-board inventory. In one embodiment, the request for usage information or data may be made wirelessly through the wireless communications system 64 on-board the machine 10.

At stage 86, the usage history or data associated with each component may be transmitted, such as wirelessly, from the remote location to the on-board controller 63 of machine 10. If a component new to the machine 10 was previously in use and transferred from another machine, the usage history or data for the new component may be transmitted by the remote system to the on-board controller 63. If the new component was not previously in use, such usage history (i.e., zero distance traveled) may be transmitted from the remote system or entered into the on-board controller 63 by an operator, management personnel, or another system. In each instance, the usage data for each new component of the undercarriage 12 may be associated with and added to the data set for such component. In other words, since the serial number for each component is unique, usage data or history for each component may be identified and transmitted to a new system, such as on-board controller 63, by identifying the new component on-board machine 10 and associating the new component with its usage data or history based upon its serial number.

For components that have been on-board machine 10, the usage data or history for such components has been previously stored within the on-board controller 63. For components that are new to the machine 10, the usage data or history may be transferred from another source such as a remote system or entered in some other manner. In any case, the usage data or history for each component is determined at stage 87. If none of the components on-board machine 10 are new to the machine at decision stage 84, the usage data or history for each component is determined at stage 87 based upon the usage data or history for such components that was previously stored within the on-board controller 63.

At stage 88, the operating conditions at the work site at which machine 10 will be operating may be determined. Such operating conditions may be determined or estimated by an operator, management personnel, or another system set. Usage thresholds for each component may be selected at stage 89 based upon the operating conditions. At stage 90, the machine 10 may be operated at the work site. During the operation of the machine 10, usage of the machine may be determined at stage 91 by any type of usage sensor or system. For example, the travel distance sensing system 56 may determine the distance traveled by the machine 10 since the start-up or the beginning of its current operation. In another example, the usage of the machine 10 may be tracked based upon the hours of usage.

The current usage data or history for each component of the undercarriage 12 stored within the on-board controller 63 may be updated at stage 92 as the machine 10 is being operated. To do so, the on-board controller 63 may begin with the previous usage data for each component and update or revise the usage data based upon the extent of usage of the machine to determine or define the current usage data.

At decision stage 93, the current usage data or history for each component may be compared to the selected usage threshold for that component. Such comparison may occur at any desired time. In one example, the comparison may occur continuously. In another example, the comparison may occur each time the machine 10 is shut down. In still other examples, the comparison may occur at predetermined intervals or upon the occurrence of certain events. If the current usage data for a component exceeds the threshold for such component, an alert may be generated at stage 94. If the current usage data does not exceed the threshold for a component, no alert is generated.

At decision stage 95, the on-board controller 63 may determine whether reporting on information from on-board the machine 10 is desired. In one example, such reporting may include any alerts generated at stage 94. Reporting the alert may include contacting the operator, management personnel, an entity responsible for service of the machine 10, and/or any other person or system. As such, the alert may be reported on or off-board the machine 10 at stage 96. In addition, usage data or history for each of the components may also be transmitted off the machine 10 to a remote location at stage 96. For example, the usage data may be transmitted to a database remote from machine 10.

Reporting of alerts and/or usage data or history may occur at any desired time period or interval. For example, alerts may be transmitted whenever an alert is generated. In another example, the alerts may be transmitted only when the machine is shut down. In one example, usage data may be transmitted each time the machine 10 is shut down. In another example, usage data may be transmitted at predetermined intervals or upon the occurrence of certain events. Some examples may include transmitting usage data daily, weekly, or monthly.

Regardless of whether alerts have been generated and reporting is desired, operation of the machine 10 may continue and stages 88-96 repeated.

Numerous alternatives to the embodiments and processes described above are contemplated. For example, although described above with the usage thresholds being stored on-board and usage data or history being compared by the on-board controller 63, in an alternate embodiment, most or a significant amount of the operation of the wear prediction and notification system 67 may occur off-board the machine 10. For example, the on-board controller 63 may determine the position of the machine 10, the amount of time operated or distance traveled, and the identity of the ID tags 70. This information may then be transmitted to a remote system such as off-board controller 111. In such case, the usage thresholds may be stored within the remote system such as off-board controller 111 and the comparison of the usage data and the usage thresholds may be performed by the remote system. In another alternate embodiment, the usage data may be stored only within the on-board controller 63 and may not be transmitted to a remote system.

In still a further alternate embodiment, usage data may be stored or written to the ID tags 70. As such, as a component is moved from one machine to another, its usage data will be transferred from the original machine to the next. During operation, the on-board controller 63 associated with each machine 10 may update the usage data at desired intervals and the wear prediction and notification system 67 may be provided with a writing system (not shown) to update the usage data stored on the ID tags 70. In such case, a database including the data sets having the serial number and usage data for each component may be eliminated since the usage data will be embedded within each component.

### INDUSTRIAL APPLICABILITY

The industrial applicability of the system described herein will be readily appreciated from the forgoing discussion. The foregoing discussion is applicable to machines 10 that are operated at a work site 100 to perform various operations. Such system may be used at a mining site, a landfill, a quarry, a construction site, a roadwork site, a forest, a farm, or any other area in which machine operation is desired.

As machines are operated, components such as those from an undercarriage 12 will undergo wear. Service intervals for maintenance, inspection, and replacement may be set for each component. Wear may depend on the operating conditions encountered by the machine and thus the service intervals may change depending on such operating conditions.

Wear prediction and notification system 67 includes a plurality of ID tags 70 with an ID tag disposed on or associated with each component to be tracked. Usage data or history for each component may be stored within a controller 61 and associated with a unique identification number of each ID tag 70. The wear prediction and notification system 67 permits service intervals to be modified based upon the specific operating conditions at the work site and permits usage data or history to follow the components even if they are moved from one machine 10 to another.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A wear prediction and notification system for a plurality of undercarriage components of an undercarriage of a machine, comprising:
a usage sensor for generating usage signals indicative of an extent of usage of the machine;
a plurality of ID tags, each ID tag being disposed on one of each of the plurality of undercarriage components and having a unique identification number;
the plurality of undercarriage components including one or more types of undercarriage components;
an ID tag reader disposed on the machine to generate signals indicative of the unique identification number of each ID tag and operatively connected to a controller such that a unique location at which each undercarriage component of the plurality of undercarriage components is positioned on the machine is transmitted to and stored by the controller, the type of each undercarriage component of the plurality of undercarriage components is transmitted to and stored by the controller, and previous usage data for each undercarriage component of the plurality of undercarriage components is transmitted to and stored by the controller;
the controller configured to:
store a usage threshold for each undercarriage component;
receive the signals from the ID tag reader;
associate each unique identification number with one of each of the undercarriage components of the machine;
determine previous usage data for each undercarriage component;
determine an extent of usage of the machine since generation of the previous usage data based upon the usage signals from the usage sensor;
determine current usage data for each undercarriage component based upon the extent of usage of the machine and the previous usage data;
compare the current usage data for each undercarriage component to the usage threshold for each undercarriage component;
generate an alert for each undercarriage component in which the current usage data for that component exceeds its usage threshold; and
transmit the alert to a system remote from the machine.

2. The wear prediction and notification system of claim 1, wherein the plurality of undercarriage components include a plurality of track links.

3. The wear prediction and notification system of claim 1, wherein the plurality of undercarriage components and the one or more types of undercarriage components include a plurality of track links and one or more of one or more idlers, one or more track rollers, one or more drive sprockets, and one or more track rollers.

4. (canceled)

5. The wear prediction and notification system of claim 1, wherein the usage sensor is a travel distance sensor for generating signals indicative of a distance traveled by the machine.

6. The wear prediction and notification system of claim 1, wherein the usage sensor is configured to determine hours of usage of the machine.

7. The wear prediction and notification system of claim 1, wherein each of the plurality of ID tags is a passive RFID tag.

8. The wear prediction and notification system of claim 1, wherein each of the plurality of ID tags is embedded in an insert disposed within a bore of one of the plurality of undercarriage components.

9. The wear prediction and notification system of claim 1, wherein the controller is configured to store a plurality of usage thresholds for each undercarriage component, each of the plurality of usage thresholds for each undercarriage component corresponding to a different operating condition at a work site.

10. The wear prediction and notification system of claim 9, wherein each different operating condition corresponds to a type of soil at the work site.

11. The wear prediction and notification system of claim 10, wherein each different operating condition corresponds to a moisture content at the work site.

12. The wear prediction and notification system of claim 1, wherein the usage threshold for each undercarriage component is stored on an on-board controller of the machine, and the on-board controller is configured to compare the current usage data for each undercarriage component to the usage threshold for each undercarriage component.

13. The wear prediction and notification system of claim 1, wherein the usage threshold for each undercarriage component is stored on an off-board controller remote from the machine, and the off-board controller is configured to compare the current usage data for each undercarriage component to the usage threshold for each undercarriage component.

14. The wear prediction and notification system of claim 1, further including an on-board controller, and the on-board controller is configured to transmit the unique identification number and the current usage data for each undercarriage component to a system remote from the machine.

15. The wear prediction and notification system of claim 1, wherein at least some of the previous usage data is stored in a system remote from the machine and transmitted to an on-board controller of the machine.

16.-20. (canceled)

21. A wear prediction and notification system for a plurality of undercarriage components of an undercarriage of a machine, comprising:
a usage sensor for generating usage signals indicative of an extent of usage of the machine;
a plurality of ID tags, each ID tag being disposed on one of each of the plurality of undercarriage components and having a unique identification number;
the plurality of undercarriage components including one or more types of undercarriage components;
an ID tag reader disposed on the machine to generate signals indicative of the unique identification number of each ID tag and operatively connected to a controller such that a unique location at which each undercarriage component of the plurality of undercarriage components is positioned on the machine is transmitted to and stored by the controller, the type of each undercarriage component of the plurality of undercarriage components is transmitted to and stored by the controller, and previous usage data for each undercarriage component of the plurality of undercarriage components is transmitted to and stored by the controller;
the controller configured to:
store one or more usage thresholds of a plurality of usage thresholds for each undercarriage component;
receive the signals from the ID tag reader;
associate each unique identification number with one of each of the undercarriage components of the machine;
determine previous usage data for each undercarriage component;
determine an extent of usage of the machine since generation of the previous usage data based upon the usage signals from the usage sensor;
determine current usage data for each undercarriage component based upon the extent of usage of the machine and the previous usage data;
compare the current usage data for each undercarriage component to the usage threshold for each undercarriage component;
generate an alert for each undercarriage component in which the current usage data for that component exceeds its usage threshold; and
transmit the alert to a system remote from the machine;
wherein the plurality of undercarriage components and the one or more types of undercarriage components include a plurality of track links and one or more of one or more idlers, one or more track rollers, one or more drive sprockets, and one or more track rollers; and
wherein the one or more usage thresholds of the plurality of usage thresholds are based upon the type of the one or more types of undercarriage components and at least one of one or more of a plurality of operating conditions at a work site at which the machine is operating.

22. The wear prediction and notification system of claim 21, wherein the plurality of operating conditions include a type of soil at the work site and a moisture content at the work site.

23. The wear prediction and notification system of claim 22, wherein the usage sensor is a travel distance sensor for generating signals indicative of a distance traveled by the machine.

24. The wear prediction and notification system of claim 22, wherein the usage sensor is configured to determine hours of usage of the machine.
